(19) United States
(12) Patent Application Publication
(10) Pub. No.: US 2020/0007254 A1
(43) Pub. Date: Jan. 2, 2020

(54) NETWORKED MOTION CONTROL

(71) Applicant: Omax Corporation, Kent, WA (US)

(72) Inventors: Kevin A. Hay, Des Moines, WA (US); Axel H. Henning, Black Diamond, WA (US)

(21) Appl. No.: 16/453,317

(22) Filed: Jun. 26, 2019

Related U.S. Application Data
(60) Provisional application No. 62/690,769, filed on Jun. 27, 2018.

(51) Int. Cl. H04J 3/06; H04L 7/00; H04L 12/933

(52) U.S. Cl. CPC H04J 3/0658; H04L 49/102; H04L 7/0012

(57) ABSTRACT

The presently disclosed technology relates to networked control of machine tools. An example system can use messages as means for transmitting intention and status in a networked control system. Illustratively, requests for actions or requests for measurements and status are passed across the network as messages rather than discrete signals. This can greatly ease machine expansion—new functions may be implemented by adding new messages on the network and adding new distributed controls to handle the new function hardware.

### CROSS-REFERENCE TO RELATED APPLICATIONS

This application claims the benefit of U.S. Provisional Patent Application No. 62/690,769 filed Jun. 27, 2018, which is incorporated herein by reference in its entirety.

### BACKGROUND

Typically, numerically controlled machine tools utilize a centralized control board (e.g., 5 axis board, 6 axis board, 9 axis board, or the like) to meter out a pre-computed actions to machine elements. The machine elements may include pumps, valves, and motor drives. Typically, each machine element is controlled with dedicated discrete signals—each signal requiring wiring dedicated to the machine element. These wires are typically routed from the centralized control board to each machine element.

### BRIEF DESCRIPTION OF THE DRAWINGS

FIG. 1 illustrates an example system with centralized control of machine tools.

FIG. 2 illustrates an example system with networked control of machine tools, in accordance with some embodiments of the present technology.

### DETAILED DESCRIPTION

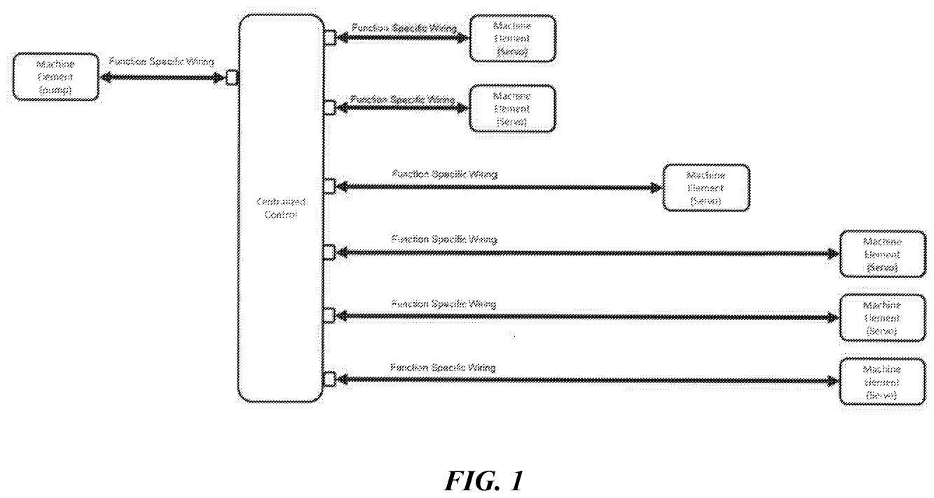

FIG. 1 illustrates an example system with centralized control. As illustrated, the wiring is function specific and routes back to a dedicated connection point on the centralized control.

Centralized control can have the following deficiencies and/or limitations:

Machine Expansion: Practical limits of machine expansion are determined by the centralized control board design. For example, a typical 6 axis control board cannot easily be expanded to control more than 6 motion axes. Similarly, a control board designed to control two pumps cannot easily be expanded to control additional pumps.

Wiring cost and Complexity: As machines become large, the time, cost and complexity of wiring machine elements to a centralized control board with function specific wiring can become significant.

Accessory Configuration Burden: As multiple machine sizes are implemented, the number of accessory configurations can become large. Each machine size may require a unique function specific wiring package to connect the accessory to the centralized control.

Computational Requirements: As machine become complex, the computational requirements of a centralized control may not be easily bounded. Each additional feature may need to be added to the centralized control. The resulting program required to implement a centralized control can become increasingly complex.

The above deficiencies and/or limitations of centralized control may be common in the machine control domain. These deficiencies can become more problematic as machines become larger and as the number of accessories or configurations increases.

The presently disclosed technology relates to a networked control approach, which can alleviate many of the concerns listed above. A networked control approach can allow controls to be distributed across the machine and located near the machine control elements. This can greatly reduce the bulk of wiring required on a machine. Distributed controls can be connected using networked wiring which is typically small and uniform in structure. Functionally specific wiring may still be required, but the lengths of these wirings may be short and the number of different lengths required is limited.

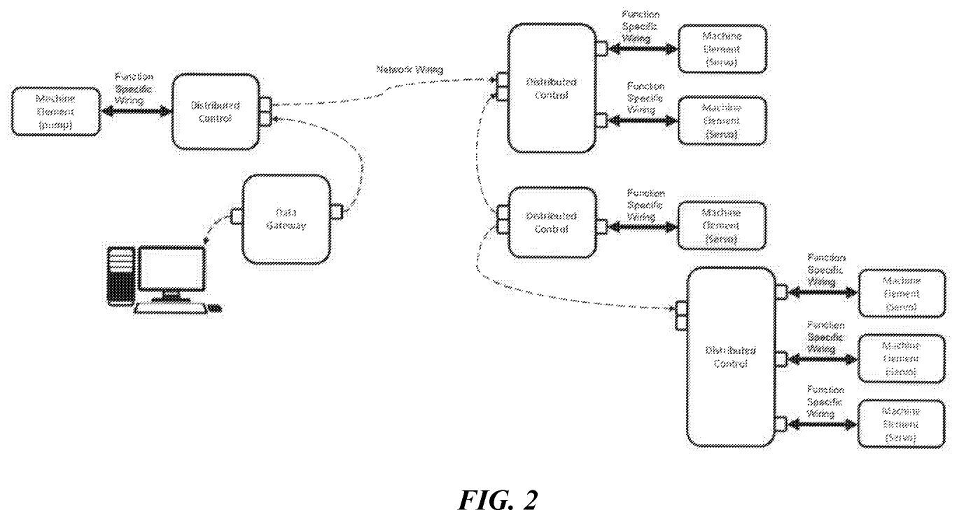

FIG. 2 illustrates an example networked control scheme.

Networked control allows for lower wiring cost, simplified expansion of the machine, and lower maximum complexity machine of individual machine control components.

In some embodiments, the presently disclosed technology uses messages as means for transmitting intention and status in a networked control system. Illustratively, requests for actions or requests for measurements and status are passed across the network as messages rather than discrete signals. This can greatly ease machine expansion—new functions may be implemented by adding new messages on the network and adding new distributed controls to handle the new function hardware.

A distributed machine control system can also allow user(s) to use the distributed controllers for different tasks such as parallel compiling of a tool path, parallel computation of the cutting model, serving different specific applications and setup screens. This approach can provide for specialized local computing, which can significantly reduce the complexity of the system.

Networked controls can come with the additional challenge of synchronizing the actions that messages instigate. This synchronization can be challenging for the following reasons:

Message Latency

The time at which a message will be received may not be entirely deterministic. This is due to a combination of software and hardware latencies. These latencies can prevent instructions that cause each networked control to “do this action right now” due to the timing uncertainty of when the message will be received and processed. Typically, message based instructions must say “do this action at this time in the future” and set that time in the future beyond any estimated latency.

Clock Drift

Each networked control device may have its own clock. These clocks can run at slightly different rates and may be prone to drifting with temperature. If the message “do this action at this time” is sent to multiple networked control devices, a poor result can occur if the devices' clocks are significantly different.

In accordance with some embodiments of the presently disclosed technology, a network for the distributed machine control can offer synchronization while maintaining the following properties:

Utilize Unmodified Ethernet

To achieve synchronized actions, many solutions may use a modified implementation of Ethernet. These modifications, however, may render the network useless for many Ethernet devices which are incompatible with modified Ethernet implementations. This can result in a small, limited set of networked devices that can be utilized—requiring special network switches, and/or specialized machine components. These specialized devices may also be more expensive due to their small market. Therefore, in accordance with some embodiments, the presently disclosed technology utilizes unmodified Ethernet and/or other unmodified networks.

Work Well in a “Tree” Network Topology

Many networked control schemes may require the network be arranged in a linear or ring topology. However, many numerically controlled machines may distribute the controls in a tree topology. Converting the linear or ring topology to a tree can require special splitter hardware or wastefully routing network wiring in a giant loop around the machine. Therefore, in accordance with some embodiments, the presently disclosed technology works with “tree” and/or “lattice” network topologies.

No Costly Additional Software

Numerically controlled machines may be produced in volumes, which can make it undesirable to need software licenses that are perpetual or ‘per machine’ in nature. In accordance with some embodiments, the presently disclosed technology does not involve costly additional software.

Three network synchronization solutions that may not be ideal are illustrated below.

EtherCAT

EtherCAT may require a Hard Real Time operating system to be running on a network master computer. These hard real time systems are costly.

EtherCAT may require motor controls that are EtherCAT compatible. As the required EtherfCAT hardware is costly, manufactures of motor controls charge a premium for EtherCAT capable products.

Deploying EtherCAT may require costly ‘bus couplers’ to transport non EtherCAT data. For example, MODBUS data may be transported on the EtherCAT network, by placing a costly bus coupler devices at the locations where MODBUS data is utilized.

EtherCAT may be best suited to a linear or ring topology. The control elements of many numerically controlled machines are arranged significantly more in a tree topology than a ring or line topology. EtherCAT may be able to implement tree like topologies, but this requires a costly ‘splitter/repeater’ device at each branch location.

CANopen/Devicenet

CAN networks can be rather slow—typically 500 kbit/sec.

CAN networks may be best suited to a linear topology. The control elements of many numerically controlled machines are arranged significantly more in a tree topology than a ring or line topology. CAN may be able to implement tree like topologies, but this requires either costly ‘splitter/repeater’ device at each branch location or acceptance of a very low data rate.

Powerlink

Power link may use Ethernet hardware to achieve real time performance and in doing this it renders the Ethernet interface useable only by Powerlink compatible devices.

In accordance with some embodiments, the presently disclosed technology utilizes Plain Ethernet with Synchronized Clocks for motion control. This approach provides the ability to utilize a distributed control system that has the following desirable characteristics:

Utilize Unmodified Ethernet

Standard Ethernet can be used. This allows the system to use the full array of low cost Ethernet hardware for creating the network.

Work Well in a “Tree” Network Topology

Standard Ethernet can inherent forms tree shaped networks. Many numerically controlled machines distribute the control hardware in a tree type structure also. This removes the need for special repeaters and splitter and allows standard low-cost switches to be utilized.

Does Not Require Costly Additional Software Components

No licensed real time operating system required.

No vendor specific licensed software required.

Illustratively, the presently disclosed technology can use the standard IEEE1588 time synchronizing technique in combination with precomputed path to achieve coordinated machine actions and motion. An example implementation includes the following elements:

A list of actions to be implemented at times in the future.
This is typically referred to as a toolpath.

Unmodified Ethernet based communications allowing this list of actions to be transmitted to distributed controls.
This can be just plain Ethernet.

IEEE1588 clock synchronization process can assure the desired actions are executed synchronously. It can provide a proven system to synchronize clocks across a network to within a few microseconds of a master clock. IEEE1588 elements can be packaged in a way that is not necessarily specific to hardware of certain numerically controlled machines.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

I/We claim:

1. A method as generally shown and described herein and equivalents thereof.

2. A system as generally shown and described herein and equivalents thereof.

3. At least one tangible, computer-readable medium carrying instructions, which when executed by at least one data processor, performs a process as generally shown and described herein and equivalents thereof.
